(19) United States
(12) Patent Application Publication
(10) Pub. No.: US 2009/0265655 A1
(43) Pub. Date: Oct. 22, 2009

(54) Navigable text user interface

(75) Inventor: Mark Geoffrey Fiedler, New York, NY (US)

Correspondence Address: Mark Fiedler, 160 Bleecker Street, #6JE, New York, NY, 10012, US

(73) Assignee: Recent Memory Incorporated

(21) Appl. No.: 12/384,928

(22) Filed: Apr. 10, 2009

Related U.S. Application Data
(60) Provisional application No. 61/045,663, filed on Apr. 17, 2008.

(51) Int. Cl. G06F 3/048

(52) U.S. Cl. 715/780; 715/854

(57) ABSTRACT

A user interface method that presents data to a user, for both inspection and modification, in the context of navigable natural-language text, providing for validation, confirmation and execution of user actions as well as integration of graphic controls.

This is the non-provisional counterpart of U.S. Provisional Patent Application Ser. No. 61/045,663 (Navigable Text User Interface), filed Apr. 17, 2008.

### FIELD OF THE INVENTION

This invention relates to the interaction between computers (among other machines) and their human users, particularly to a user interface that presents data to a user, for both inspection and modification, in a navigable text context.

### BACKGROUND OF THE INVENTION

Before the adoption of graphical user interfaces and the video devices supporting them, the human-computer interface generally took the form of a text dialogue in which the machine would respond to the user's typewritten commands by typing something back, generally ending with a prompt or question awaiting the user's response, which would generally elicit a further typed response from the computer, and so on. Such ‘teletypewriter’ exchanges tended to minimize the typing required of users, keeping commands and responses short, if sometimes cryptic—whereas the computer's part of the dialogue tended to be verbose, presenting a continuous, explanatory narrative in something as close to natural language as was practicable. Although this generally presented the user with data in the context of an explanatory text narrative, the user was not afforded access to data in that context and therefore had to refer to any such data by other means; and any overall picture of the data was left to the user's imagination.

Current graphic user interfaces are significantly better at presenting something approaching an overall view of data. At its best, a graphic user interface can show complex relationships among data elements in a single view, allowing those relationships to be visually scanned, navigated and intuitively understood. On the other hand, it is neither practical nor desirable to banish text entirely from the user interface. To begin with, the individual data elements represented in any user interface context—essentially strings and numbers—consist entirely of text, particularly if numerals are included along with alphabetic or other word symbols. (The icons used in graphical user interfaces to overcome language barriers are essentially word symbols, which however often resist interpretation and cannot be searched.) Moreover, some text is needed to provide context for data: Points and axes on graphs must be identified; scales are needed to interpret lengths and areas; and the relationships represented by lines connecting things in diagrams must be explained.

Current practice generally relegates such explanatory text to labels (in graphic presentations), legends (presented alongside, above or below graphics) and help facilities (entirely separate from the graphics, although a help facility may include “samples” of those graphics). Legends and particularly labels must be confined to relatively small areas, so they typically present short phrases of text (often in minuscule type) without adequate context for interpretation. Help facilities, in general, do provide a continuous text narrative that discloses the context underlying the data represented in a graphical user interface, along with a general discussion of possible data and data relationships, as well as general instructions for navigating and modifying data. But this narrative is fixed, and cannot make particular reference to the actual state of the data confronting the user. To attain any needed or desired level of proficiency with a software application, a beginning or casual user must typically make a number of trips between the help facility (and/or other instructional material) and the application itself.

All of this contributes to the ‘learning curve’ that all users must climb. And the proliferation of software (in all forms) that has come with the Internet, making most users casual users, has only aggravated the challenge.

A presentation method that integrates data with explanatory text for any suitable level of expertise, presenting data elements (for inspection and possibly modification) in the context of a continuous text narrative, would be of advantage. Although such data-bearing text would not be suitable to replace all graphic aspects of the user interface—after all, a picture is proverbially worth a thousand words—it would be of particular utility, for both casual and more expert users, in presenting the context for graphic representations of data, accompanying and reinforcing such representations with explicit descriptions of what they mean, and explicating the user's options for navigating and modifying the data.

(It may be argued that the current technology of hypertext, particularly the ubiquitous hypertext markup-language (HTML), does allow data elements to be presented for inspection and modification through controls in the context of a continuous text narrative, even though such controls are usually deployed in tabular forms (with optional text labels) rather than in continuous text. Controls deployed in continuous text, however, not only suffer from aesthetic problems (i.e., they are of a fixed size, they cannot break across lines of text, and their appearance breaks up the continuity of the text), but they are of limited functionality. For example, no action on such a control can have any effect on the text in which it occurs.)

In addition to the drawbacks noted above, the implementation of a current user interface involves a significant degree of effort in the design and implementation of a graphic layout. Although some application frameworks provide a limited degree of automation in the relative placement of user-interface elements, the locations of elements are largely fixed, and any significant change in their layout requires considerable human effort in rearranging them.

A number of further drawbacks result from the fixed arrangement of text and graphic elements in current user interfaces, along with the general inability to reconfigure the narrative or the arrangement of data screens in response to changes in data. Prompts or warnings to the user (if any) regarding possible consequences of a pending action are relegated to either a ‘status line’ at the bottom of the screen window or to a ‘pop-up’ window that may obscure the user's current location. In another example, data entry controls that become inapplicable as a result of (changed) data values are simply disabled without explanation.

In addition to the effort involved in designing and implementing the layout of a graphic user interface, there is considerably more effort involved if the user interface provides for modification of data values. In general, data input by a user cannot simply be accepted by a software application. It must usually be validated, and unacceptable values need to be presented and explained to the user (and in the user prevented from entering them). Further, the user's intention, particularly in cases of deletions, must often be confirmed—that is, the user must be apprised of the consequences of his or her action before the action can proceed. The steps of validation and confirmation need to be properly recognized, designed, implemented, bound to their corresponding data-entry controls, and invoked at appropriate points in the data entry process: achieving this is often an arduous, error-prone task.

Accordingly, there is a need for a method of presenting a user with data in the context of a continuous text narrative that discloses the underlying context and relationships among the data elements, allowing a user to navigate through the text narrative to inspect and possibly modify data, indicating (in proximity to the user's current location) the user's options as to possible actions (‘next moves’) and their possible consequences, and having the text narrative change appropriately in response to any of the user's actions, particularly modifications of data.

It is an objective of the present invention to address the need for such a user interface method. Further objectives of the present invention are:
(1) to simplify and accelerate the process of user interface development, replacing a significant portion of the work of laying out graphics with scripting of text,
(2) to facilitate the implementation of user interfaces in disparate natural languages
(3) to foster thoroughness in the development of data entry functionality, supporting (and encouraging developers to address) all stages of data entry in each instance
(4) to provide for the integration of graphical elements with the text, informed by the same data-handling apparatus as the text

### SUMMARY OF THE INVENTION

The present invention comprises a user interface that presents data for inspection and possible modification by users in the context of a continuous text narrative, which address the above objectives by:
(1) providing a scripting procedure for the narrative text, including the placement of data-bearing phrases,
(2) organizing the scripted text as semantic nodes (discussed below), thereby facilitating implementation in disparate natural languages,
(3) providing for the scripting of dialog with the user at the various stages of data entry, including validation of entered values and confirmation of the user's intent, and
(4) providing for the integration of graphical elements with the text, informed by the same data-handling apparatus as the text

### BRIEF DESCRIPTION OF DRAWINGS

Various terms used in the following brief description are more fully explained in the Detailed Description of the Preferred Embodiment, below.

FIG. 1 shows a page of navigable text, with a cursor on the marginal locus of the first paragraph, which is closed.

FIG. 2 shows the same page with a cursor on the main text of the first paragraph. The paragraph is open, displaying the available action nodes. Also displayed is a locus trail in the margin.

FIG. 3 shows a subsidiary roster (in this case, a phrase action roster) on an open phrase.

FIG. 4 shows a cursor on the current item of the same subsidiary roster, with a subsidiary cursor on that item and a stationary cursor at the main locus.

FIG. 5 shows a stationary cursor at a page's single visitable phrase—in this particular case, an open edit phrase.

FIG. 6 shows a cursor on the current item of a phrase roster, with an action roster open for that item.

FIG. 7 shows an open paragraph with a cursor on the marginal locus of an action (propose) node.

FIG. 8 shows the same open paragraph with the cursor on the launch locus of the same action node, with an outboard cursor element at the action node's single visitable phrase.

FIG. 9 shows the same open paragraph with the cursor on the locus of the same action node's single visitable phrase.

FIG. 10 shows the same open paragraph with the cursor on the launch locus of an action node without any visitable phrases, with the node's entire text highlighted.

FIG. 11 shows a page in the validation stage of an action, with a subsidiary dialog showing a response node indicating the user's error and a prompt indicating the user's possible next move.

FIG. 12 shows the same page at the confirmation stage of the same action, with a subsidiary dialog showing no a response but showing a prompt indicating the user's possible next moves.

FIG. 13 shows a closed paragraph containing an empty underscore in the place of an edit phrase with no data value.

FIG. 14 shows the same paragraph, open, with an editor on the still empty edit phrase open for character entry. This is indicated by a highlighted area that includes the main cursor element as well as the system caret (indicating the current character position), with “headway” provided for character entry beyond the caret.

FIG. 15 shows the same edit phrase, with one character entered. The word fragment comprising the entered character is highlighted a level above the highlighted entry area. The cursor on the text area has become a stationary cursor, while the current (subsidiary) cursor is on the current item of a hint roster of available words beginning with the entered character; the current item is highlighted at the same level as the entered word fragment.

FIG. 16 shows an open selector phrase, with a subsidiary roster of available alternative choices.

FIG. 17 shows a graphic control, in this case a pushbutton with text, embedded in a phrase sequence.

FIG. 18 shows the current mouse locus, with its foreground and background colors reversed.

FIG. 19 shows the mouse located on a paragraph comprising a visitable node without visitable phrases, with the node's entire text shown with its foreground and background colors reversed.

FIG. 20 shows a blank edit phrase as the current mouse locus.

FIG. 21 shows a current mouse roster item in an open subsidiary roster, in this case a phrase action roster.

### DETAILED DESCRIPTION OF THE PREFERRED EMBODIMENT

Described below is an implementation of a navigable text user interface, expressed in terms of object-oriented design. This implementation is provided in order to enable those skilled in the art to implement this invention. Although the implementation described here teaches behavior that is specified in terms of this implementation's particular object classes, and may describe some behavior (of visible and/or manipulable objects) only in terms of such object classes, it is the behavior itself (as well as the objects involved, as both are experienced by a user)—insofar as the same is novel, useful and unobvious, and supports the claims below—that constitutes this invention, no less than the implementation. The implementation described here may be only one of a number of possible object-oriented designs that would produce identical behavior. Moreover, this implementation makes use of the existing graphics-user-interface functionality under the popular Microsoft Windows family of operating systems—which may well be superseded by different implementation platforms, possibly better suited to the present invention. In a similar vein, object-oriented design is itself only one of a number of effective implementation paradigms, both existing and yet to be invented, including any that may arise (directly or indirectly) from the present invention.

The preferred embodiment of the present invention is disclosed here, for the sake of clarity, by way of a functional description that aims to teach the implementation of its essential components to the extent that such implementation would not be clear to those skilled in the art: this allows some latitude for implementation. In particular, the implementation disclosed here makes use of pointers or references to data objects—fundamental elements of object-oriented design, by means of which data objects may refer to other data objects. Where an object is said to have a pointer or reference to a second object (or is said to refer to, “maintain” or “carry” the second object), this is meant to refer to all possible cases of implementation: whether the first object contains the second, or the first contains a pointer or a reference to the second, or even a case where the first contains a pointer (or reference) to a third object which in turn refers to the second, or the first object (indirectly) refers to the second through a chain of similar references; and regardless of the nature of these references, whether they are addresses of data locations, ‘handles’ assigned by the system to identify objects, string- or numerical-valued database keys, hashes, maps, indices, or whatever.

At a more basic level, it is generally understood that aspects of the present invention may be implemented with instructions that can be executed on a computing device (broadly understood to include more or less dedicated devices such as cellular telephones and other, generally small or handheld devices, which may have limited computing ability) in the general context of computer-executable instructions, such as program modules, executed by one or more computing devices. The technology of computing devices and computer-executable instructions is well known: program modules generally include routines, programs, objects, components, data structures, etc. that perform particular tasks or implement particular abstract data types; and the functionality of program modules may typically be combined or distributed as desired. It is well known, moreover, that computer-executable instructions are stored on computer-readable media, loaded into memory and executed by a processor on data that is similarly stored and loaded. For the sake of clarity and simplicity, the implementation disclosed here assumes these underlying technologies and general knowledge thereof, without limiting this assumption to their present state. These technologies may be expected to evolve, but their application to the present invention will continue to be clear to those skilled in the art.

In the following discussion, the directions left and right (as well as up and down, top and bottom, above and below) are specified on the basis of languages (using, among others, the Roman, Greek, Cyrillic and Devanagari alphabets, as well numerous Eastern writing systems) that are written in horizontal lines from left to right, with the sequence of lines proceeding down the page. Appropriate substitutions should be made in cases where other writing systems are used—such as Hebrew or Arabic, written in horizontal lines from right to left; or traditional Chinese, written in vertical lines from top to bottom, with successive lines proceeding from right to left.

Template Elements: Phrases and Nodes

The navigable text employed in this invention is composed of sequences of phrases. A phrase may be a text phrase, displaying a fixed text; a constant phrase, displaying an invariant data value that cannot change once it is loaded, or a full-fledged data-bearing phrase, displaying a data value that may be changed and so possibly change the text context in which it appears. A roster phrase is a data-bearing phrase (constant or variable) capable of carrying multiple values, which are displayed in a rectangular arrangement (i.e., in rows and possibly columns) termed a roster.

Data-bearing phrases, including constant phrases, are implemented as subclasses of a general abstract phrase class. There are also data-bearing edit phrases and select phrases as well as control phrases (all discussed below), which accept data as input from the user. All phrase classes are derived from a single abstract phrase class. Particular types of data-bearing phrases, carrying domain-specific data, are implemented as subclasses of the phrase class or of the abstract editor-, selector- or control-phrase class, as applicable. The functionality of all of these is discussed below under Editors, Selectors and Graphic Controls.

A node (more formally, a semantic node) is an object corresponding to a sequence of phrases expressing zero or more data values, which sequence may be varied according to the data values being expressed. As realized, nodes may contain any combination of text phrases, constant phrases and data phrases (whether single- or roster-valued) as well as editor, selector and control phrases.

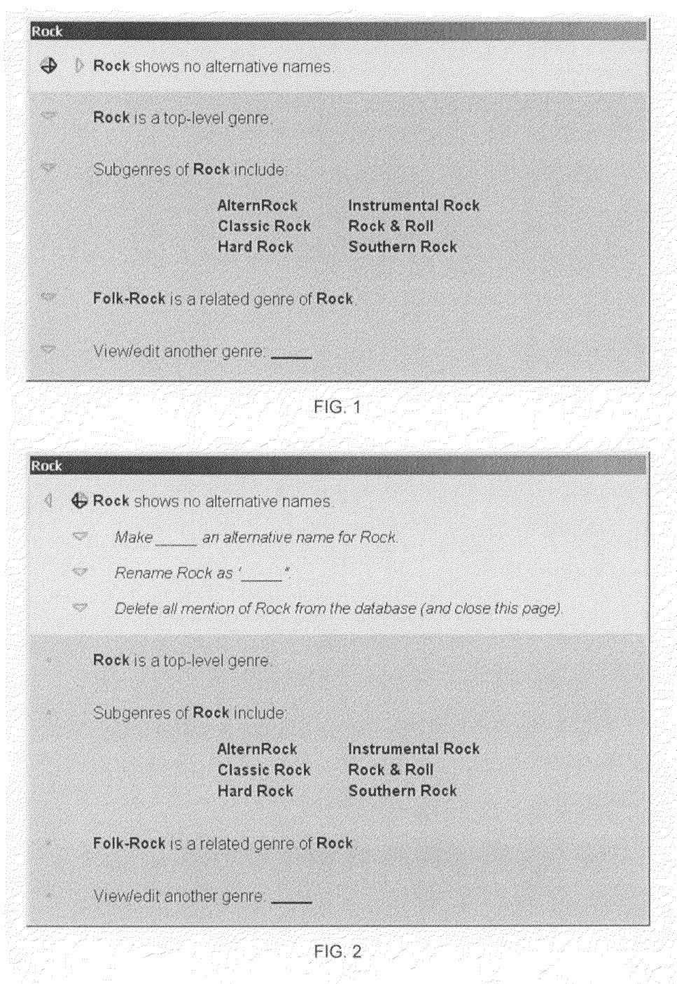

As will be seen from the following discussion, this flexibility enables the user interface to present data in a more expressive context than would be feasible using fixed strings of text. It is of particular advantage in expressing and explaining the lack of data in particular contexts, especially compared with the fixed labels and empty controls currently in use. For example, as will be seen in FIG. 1 below, in the case of a (music genre) term without any broader (supergenre) terms, it is of advantage to state: “Rock is a top-level genre,” rather than show an empty list of “Supergenres of Rock.”

Moreover, the organization of text into nodes helps to encapsulate the more or less idiomatic features of the natural language being used, facilitating translation of the user interface between disparate natural languages.

Actual Data Elements: Pages, Paragraphs and Phrase Data Objects

Specific data values and the text in which they are represented are displayed on pages, each of which corresponds to a window in a graphic user interface. An actual page is composed of a succession of paragraphs, each representing actual data. As with phrases, specific types of pages and paragraphs are implemented as subclasses, respectively, of an abstract base page class and an abstract base paragraph class. It is these subclasses that carry the domain-specific data.

Typically a page will have a specific data element as its subject, and each of its component paragraphs will display some distinct aspect of the subject data element's properties and/or relations. In the thesaurus example illustrated here, each page is associated with a term in the thesaurus; accordingly, the term page object (derived from the abstract page object) carries a pointer (or reference) to its subject term. The page's first paragraph (termed the usage paragraph) shows the term and its aspect (here, terms represent genres of music) as well as any terms that are non-preferred synonyms for the term. The page's remaining three paragraphs are relation paragraphs. The first of these shows broader terms for the subject term (represented as its “supergenres”), narrower terms (represented as its “subgenres”), and its related terms (represented as its “related genres”).

In the general case, the page need not have any subject data, and its component paragraphs may refer to disparate data elements that need not be mutually related. Moreover, data contexts other than paragraphs and pages, each with its own independent data, may be shared by two or more paragraphs or pages; and two or more data contexts may similarly share a further data context.

A paragraph of any particular type contains a fixed succession of one or more nodes. The text of a paragraph is constructed and displayed in four distinct stages:
(1) Each of its component nodes is realized as a specific sequence of phrases that generally depends on the paragraph's actual data values. This process, achieved through a process of scripting, occurs initially and whenever triggered by changes in the relevant data values—i.e., those of the paragraph, the page or any data context associated with the paragraph. (Each data context keeps track of the paragraphs and/or data contexts that share it. An appropriate set of change flags associated with pages, paragraphs and other data contexts, set by routines that change their data, signals the need to re-realize them.)
(2) Within each realized node, the phrase data object that corresponds to each data-bearing phrase is refreshed, initially and whenever the relevant data values change, by means of a refresh function specific to each phrase.
(3) The text of each successive node (with its phrase sequence realized and its data refreshed, yielding the actual complete text) is rendered on the page in memory. This produces the actual sequence and layout of the page as it will appear to the user, initially and whenever modified by some action on the part of the user, such as a keystroke or mouse movement.
(4) The page is painted on the graphical device, initially and whenever triggered by the requirement to (re)paint all or the relevant part of the page's window.

Following is a discussion of these steps in detail, introducing further classes of objects involved.

Realization and Refreshment, Scripting and Loci

Each particular (domain-specific) node subclass implements its own unique realize function, which builds the phrase sequence by making successive calls to a generic scripting function, generally under the control of program logic, using data from a given paragraph.

Following is an example (in C++) of a scripting function for a relation node in the present example of a thesaurus:

```
void cRelationNode::realize( cParagraph* pPara )
{
    cRelationParagraph* pRPara = ( cRelationparagraph* )pPara;
    CTypedPtrArray< CPtrArray, cTerm* >* papLinks = pRPara->
        getSource( );
    switch ( papLinks ? papLinks->GetSize( ) ; 0 )
    {
        case 0:
            script( 0, pPara, “\hat{ } ”, gphSourceTerm );
            if ( pRPara->getInverse( ) )
                script( 1, pPara, “is a top-level \hat{ }.”, gphAspect );
            else
                script( 2, pPara, “has no \hat{ }.”, gphRelations );
            break;
        case 1:
            script( 3, pPara, “\hat{ } is a \hat{ } of \hat{ }.”, gphFirstTerm,
                gphRelation, gphSourceTerm );
            break;
        case 2:
            script( 4, pPara, “\hat{ } and \hat{ } are \hat{ } of \hat{ }.”, gphFirstTerm,
                gphSecondTerm, gphRelations, gphSourceTerm );
            break;
        default:
            script( 5, pPara, “\hat{ } of \hat{ }: \hat{ }”, gphCapRelations,
                gphSourceTerm, gphAllTerms );
            break;
    }
}
```

In the above example, papLinks is a pointer to the term paragraph's array of subordinate terms for its source term. The size of this array (returned by its member function GetSize( )) determines the particular calls made to the scripting function. These successive calls to the scripting function build a series of references to phrases that will constitute the text of the paragraph, reflecting the paragraph's data.

This example makes use of global pointers (or references) to data-bearing phrases, whose text is realized as follows: Each data-bearing phrase (constant phrases included) has a refresh function that loads the data value that the phrase displays. On first loading the phrase, or (for data phrases) whenever the data value changes, the refresh function is called with a pointer (or reference) to the paragraph as an argument. Thus the paragraph serves as the source of the data.

As for the global phrase pointers used in this example:

gphSourceTerm refers to a term phrase whose refresh function loads the paragraph's source term,

gphFirstTerm and gphSecondTerm refer to term phrases whose refresh functions, respectively, load the first and second of a term paragraph's subordinate terms,

gphAllTerms refers to a term roster phrase whose refresh function loads the first and second of the paragraph's subordinate terms,

gphAspect, gphRelations, and gphRelations gphCapRelations refer to constant phrases whose refresh functions load, respectively, the (constant) names of the relevant aspect and the subordinate-term relation (plain, plural and capitalized).

The scripting function script( ), a member of the base node class, takes a variable number of arguments:
(1) First, a unique integer for each call to script( ) within a realize function. The first time each particular call is made, script( ) builds a fixed sequence of phrase pointers (or references), as described below, and enters this sequence in a script map associated with this node that maps this unique integer to the phrase pointer sequence. Subsequent calls look up the integer key in the script map to access the phrase pointer sequence. (A line-number macro, which translates to the position of this line of code in the source file, may be used for this integer key value to ensure its uniqueness.)
(2) Next, a pointer (or reference) to the relevant paragraph,
(3) Next, a text string employing a dedicated token (here, the caret character) as a placeholder for each data-bearing phrase, and
(4) Finally, (zero or more) pointers (or references) to the phrases referenced by the phrase tokens, in the order in which they occur.

Thus the result might read: “Progressive Rock is a subgenre of Rock.”

The scripting function builds a phrase sequence according to the text string argument, placing a pointer to each data-bearing phrase at the position of the corresponding caret.

Thus the calling line

script (3, pPara, “̂ is a ̂ of ̂.”, gphFirstTerm, gphRelation, gphSourceTerm);

constructs three new text phrases and produces a sequence of pointers to these and the three data-bearing phrases of the last three arguments, as follows:
(1) (a copy of) gphFirstTerm, which points to a (data-bearing) term phrase whose refresh function loads the first of the paragraph's subordinate terms (in this case, the only subordinate term);
(2) a new text phrase with the fixed string “is a”;
(3) (a copy of) gphRelation, which points to a (data-bearing) relation-name phrase (a subclass of constant phrase) whose refresh function loads the name of the subordinate-term relation. for the paragraph's aspect (here, “subgenre” for the aspect “genre”);
(4) a new text phrase with the fixed string “of”;
(5) (a copy of) gphSourceTerm, which points to a (data-bearing) term phrase whose refresh function loads the paragraph's source term (in this case, the page's subject term); and finally
(6) a new text phrase with the fixed string “.”;

Using the script map described above prevents redundant parsing of the string argument to script( ) and ensures that the text phrases involved are constructed only once.

Once the sequence of phrase pointers for a node in a paragraph is built, a corresponding sequence of loci is constructed. Each locus in this sequence corresponds to a phrase, and carries the physical location of its phrase on the display (to be determined later, during the rendering process) as well as links to each of its neighboring loci (if any) in the four screen directions (i.e., rightward, downward, upward, and leftward). Thus, the series of rightward links beginning with the first locus reflects the phrase sequence. Each locus refers to its phrase indirectly by carrying a pointer (or reference) to a phrase data object. Each subclass of phrase object, including domain-specific ones, has a corresponding type of phrase data object, which carries a value, or a pointer or reference to a value, of the appropriate data type. This value is refreshed in the course of building the locus sequence, using data from the paragraph, by the corresponding phrase's refresh function.

Each locus also carries a pointer (or reference) to the node object that is the source of the phrase sequence in its which its phrase occurs. When the phrase sequence needs to be changed as a result of changed data, this node pointer is used to compare the new phrase sequence with the existing locus sequence for the node. The first existing locus (if any) associated with the node that does not match the new phrase sequence, as well as any loci to its right that are associated with the same node, are destroyed, and new loci constructed and linked together in their place to reflect the new phrase sequence.

Each paragraph carries a single phrase data object corresponding to each phrase used by the paragraph, regardless of how many times the phrase may occur in the paragraph's text. This is reflected in the paragraph's phrase data map, which maps (the address of) each phrase to (the address of) the paragraph's corresponding phrase data object. Whenever a new phrase-bearing locus is constructed, the address of the locus's phrase is looked up in the data map. If an entry for the phrase is found, the locus's phrase data pointer is set to point to the phrase's existing phrase data object for the paragraph (to which the phrase is mapped). If not, a new phrase data object is constructed for the phrase, the phrase's correspondence with it entered into the phrase data map, and the locus's phrase data pointer assigned to it. In either case, the phrase data object's data value is then refreshed from the paragraph's data.

It will be seen that the page and paragraph objects (among other data contexts) serve as data containers, separate from the application's data store. They are also separate from the phrase data objects, which are refreshed with data from a paragraph and also (as discussed below) propagate user-entered data to the paragraph. This sequence of separate data containers—phrase data object, paragraph, page, application data store—is of utility in implementing data persistence according to well-known methodologies.

It may be further observed that the composition of a page—that is, the choice and order of its component paragraphs, as well as their content—may be controlled depending on the state of the actual page data, which is available at the time the page is realized. Pages are composed procedurally, by adding paragraphs in order, including or excluding specific paragraphs on the basis of page data. In more general terms, the application-specific components are specified in a combination of declarative and procedural statements. Phrases, for example, are constructed using pointers to their refresh functions as arguments; and the set of actions (see below) associated with a particular node or phrase is built procedurally, adding one action at a time. This suggests the feasibility of a scripting language, which would advantageously incorporate the same kinds of logical control-flow constructs (e.g., conditional testing and branching) as the programming language used for scripting in this implementation On the other hand, the implementation of this user interface in an actual programming language advantageously provides the full power and familiarity of that language, which may be difficult to replicate in a scripting language.

(Another possible alternative to the implementation discussed here may be worth mentioning: Instead of providing phrase data objects separate from loci, the locus class might be subclassed to incorporate the data (whether or not domain-specific) that would otherwise be included in phrase data objects, with each locus subclass associated with the appropriate phrase subclass. This, however, would present some drawbacks. One is that disparate loci carrying the same data within a paragraph would carry redundant copies of the same data; another is that non-data-bearing loci (such as marginal and launch loci, discussed below) would need to be specifically identified rather than simply carrying null pointers or references phrase data objects. A further alternative is to maintain, in place of the paragraph's phrase data map, a map that maps each locus in the paragraph to a phrase data object; this scheme may be somewhat less efficient than the scheme involving the phrase data map described above.)

It may be desirable, in some cases, for a node's realize function to produce no text for certain values of the paragraph's data—particularly where the paragraph data is empty or lacking and the lack of data is deemed not particularly worth mentioning. A paragraph may thus consist entirely of such empty nodes. Such an empty paragraph should be skipped over in a realized page's sequence of paragraphs.

Paragraphs and the Locus Network

Any locus carrying a phrase on which the user may perform an action (which generally involves inspecting or modifying data, as detailed below) is said to be visitable. (The phrase, as realized in the paragraph's realized text, is also termed visitable.) The user's current location in the user interface at any given time is represented by at least one cursor (discussed in detail below) which can be moved from one visitable locus to another. The marginal and launch locus of any paragraph bearing action nodes are also visitable, so that the paragraph may be opened to reveal its action nodes (see below; FIGS. 1 and 2).

Besides the left-to-right sequence of loci that carries its realized phrase sequence, each paragraph (except, possibly, those without any visitable phrases) has two additional loci: a marginal locus and a launch locus.

Each paragraph's marginal locus is located in the left-hand margin of the page, and is linked downward to the marginal locus of next paragraph (if any) and upward to the marginal locus of previous paragraph (if any). The user's current location (by means of a cursor, discussed below) can thus move between paragraphs by moving up or down on the vertically linked marginal loci.

Linked to the immediate right of a paragraph's marginal locus is its launch locus. Moving the cursor from a paragraph's marginal locus onto its launch locus opens the paragraph, which causes the paragraph's visitable loci and node actions (both as discussed below) to be displayed; moving the cursor back to the marginal locus closes the paragraph, hiding those items. Opening a paragraph generally expands its displayed test, as a result of displaying these items. (Conversely, suppressing these items in paragraphs that are not open reduces visual clutter on a page.) Providing both a marginal locus and a launch locus for each visitable paragraph avoids the possible distraction of having paragraphs quickly open and close—generally with a displacement in position—as one moves down the page.

Rendering

As described above, the realization process builds a network of loci carrying the phrase data objects that correspond to phrases of text. The subsequent process of rendering determines the physical location of the loci and provides for the physical display of the text.

Rendering a page involves rendering each of its paragraphs, from top to bottom. When the text of a paragraph changes, the resulting rendering begins with that paragraph and covers the remainder of the page. Each paragraph is rendered as follows:
(1) If the paragraph is closed, the left-to-right sequence of each node's phrase-bearing loci is rendered in turn, forming a continuous block of text. This text block is indented from the left margin, allowing space for the paragraph's marginal locus (at the margin) and launch locus (to its right).
(2) If the paragraph is open, the locus sequence of each node is rendered as a separate subparagraph (i.e., a continuous block of text), followed by the propose nodes of each of its associated actions (see below), if any, each rendered as a separate subparagraph. (The placement of these subparagraphs and their marginal and launch loci is detailed below under “Actions, in Detail.”)

Paragraphs and subparagraphs are set in from the edges of the window by a margin, and are separated from each other by vertical spaces. The extents of these are determined by the page's style (see below).

The left-to-right locus sequence of each (sub)paragraph is rendered as follows: The first locus is placed at the (sub)paragraph's margin, and the horizontal extent of its text (as it will be rendered) is determined using the device context. The next locus, linked to the immediate right of the first locus, is placed to its right, at a distance from the margin equal to the horizontal extent of the first locus. Each subsequent locus, following the rightward links, is similarly placed in turn.

In the course of rendering this left-to-right sequence of phrase-bearing loci, the horizontal length of the phrase sequence to be rendered will often exceed the available line width. Thus arises the need for word wrapping, as commonly employed in word processors, browsers and other text-handling software, i.e., breaking the line at a space (or other suitable character) and starting a new line with the remainder of the text. In the present scheme, in which the phrases carried by loci will generally contain multiple words, word wrapping is achieved by means of locus replication, as follows:

When the horizontal extent of a locus, as placed in the sequence, exceeds the available line width, the system searches backwards through the text of that locus (from the end to the beginning) for a space or other appropriate point at which to break the line. If no space or other suitable character is found, the system searches backwards (in the same manner) through the text of each of its leftward neighbors in turn, continuing until the line's first locus—designated the line locus—has been searched.

This process may fail if no space or other dividing point is found for a given line. (Certain other processes, such as rendering rosters, may also require more than the available width and similarly fail.) In all such cases, this failure invokes a new rendering of the page in a window that has been widened to (at least) the required width. As the new rendering may also fail, the process is repeated until the page is successfully rendered.

If, on the other hand, the search has found a suitable breaking point, the locus carrying it is replicated, that is, a new locus, carrying the same phrase data object, is created and linked into the locus sequence to right of the original locus. The text of the original locus is segmented between the original locus and the new locus, which carries the segment of the original text following the breaking point. This segmentation is implemented as follows:

Each locus, whether replicated or not, carries an integer value designated its text offset. For undivided phrases this value is zero. When a phrase is divided into segments carried by a sequence of replicated loci, the first locus has offset value −1, and each subsequent locus a value equal to the offset of its first text character from the beginning of the phrase. (The end (or the length) of a locus's text segment is thus determined by checking the text offset value its rightward neighbor: if it is 0, the text segment is the remainder of the phrase; otherwise it ends just before that offset.)

When a breaking point is found, the locus carrying that segment of the text may already be replicated, in which case the text offset of right-hand locus may need to be changed to reflect a new breaking point. Otherwise, the locus is replicated, the left-hand assigned an offset of −1 and the right-hand locus the offset of the breaking point. The line, up to and including the left-hand locus, is then rendered, and the right-hand locus is designated the new line locus and placed at the left margin on the next line.

This process of placing loci, wrapping and rendering lines is repeated until the entire text of the (sub)paragraph has been rendered. When the last locus in the paragraph has been placed, the last line (from the line locus to the last locus) is finally rendered.

It will be seen that, as lines are broken at different points and loci are accordingly replicated and adjusted, the logical sequence of the loci is preserved along with the continuity of the text.

In placing each locus, the vertical as well as the horizontal extent of its text area is determined. (This vertical extent may advantageously be adjusted to align the baselines of the various fonts used. These vertical adjustments (termed shims) will be constant for each logical font; each of them is thus advantageously stored in a kit with its associated font. The shim for each font is advantageously computed from the distance between the top and the baseline.) The height of a line of loci, as rendered, is equal to the maximum vertical extent of any of its loci. In rendering a line, the text of each locus is displaced downward from the top of the line to the extent (if any) that its height falls short of the line height (or the extent, if any, needed to align its font's baseline), so that the bottom edges of the text areas of all the loci are placed flush.

(The process of rendering a line at a time will be seen to allow for such effects as justification, centered or right alignment of the text, the implementation of which will be clear to those skilled in the art.)

It is also in the course of rendering a line that the current (cursor) locus is detected and its appurtenances (action rosters, prompts, subsidiary dialogs, etc.—all of which see below) are rendered. These appurtenances will generally additional vertical space of their own, displacing any subsequently rendered lines downward. Any desired leading (i.e., extra vertical space between lines) is advantageously added between rendered lines.

When the rendering process encounters a roster phrase, the paragraph is broken at that point and the line (from the line locus, up to but not including the locus carrying the roster phrase) is rendered. If a locus follows (i.e., is linked to the right of) the roster phrase, it begins a new line (as the line locus) below the roster phrase.

Roster phrases are rendered as follows: If the number of roster elements exceeds a certain minimum, the system attempts to display the roster in multiple columns. The number of columns for the first attempt is determined by dividing the available page width (counting uniform gutter spaces between columns, plus the cursor offset in case the roster phrase is visitable) by the average horizontal extent of the roster items. If this arrangement proves too wide for the page, a further attempt is made with one fewer columns. This process is repeated until either it succeeds, or it fails with a single column. In the latter case, the entire page is rendered anew in window that has been widened to (at least) the required width. As the new rendering may also fail, the process is repeated until the page is successfully rendered.

When a page has been successfully rendered, its vertical extent is advantageously adjusted to show the bottom margin predetermined by the page's style object.

The initial rendering of the page produces its sequence and layout, including physical coordinates for all of its contents. Once this is complete, these data are used to paint the page on the graphical display device, using the applicable kits, in a process essentially parallel to the rendering process.

Rendering and Painting

Partial rendering of a page is triggered by any change in the page's content, e.g., a change in the value of a data-bearing phrase or phrases. (This in turn may be the result of refreshing a phrase data object or realizing a node, or merely moving a cursor.) When a locus changes position, the change typically affects the positions of loci to its right and below it.

In general, any such change will generally affect a range of loci on the page, represented by pointers to a first locus and either a last locus (i.e., the last locus affected) or an end locus (i.e., its immediate right-hand neighbor). The rendering process begins with the first locus, which may be assumed not to have changed position but may have changed its horizontal or vertical extent, and proceeds rightward and downward until the end locus, if any, is encountered. (If the first locus is null, rendering begins at the top of the page; if the end locus is null, rendering proceeds to the bottom of the page. If a last locus has been specified rather than an end locus, the end locus is determined to be the first locus encountered in the rendering process whose vertical position is below that of the last locus.) If the end locus is encountered by the rendering process, rendering terminates if the end locus is found not to have changed position. Otherwise (i.e., if it has shifted), the end-locus pointer is made null, and rendering proceeds until it either encounters a locus which has not changed position (to which the end-locus pointer is then assigned) or reaches the bottom of the page.

The values of the first- and end-locus pointers at the end of the rendering process determine an invalid rectangle to be re-painted—i.e., a rectangle having the width of the page (excluding the outer margins, including the positions of the first and end loci.

When implemented in a graphical environment such as Microsoft Windows, the painting process is driven by a paint message that typically originates from the graphical environment in response to an event such as a change in the data being displayed. The paint message makes use of a device context that relates the properties of text (e.g., fonts, colors) to the characteristics of the graphic device on which it is to be displayed.

Care must be taken to ensure that first-, last-, and end-locus pointers do not point to loci that have been destroyed, particularly when all or part of a page is re-realized as the result of changed data. In such cases, the affected locus pointers should be set to extant loci just outside the area to be re-rendered—e.g., a first-locus pointer so affected should be set to the paragraph's launch locus or, if the paragraph is empty, that of the first non-empty paragraph following.

The processes of scripting, realization, rendering and painting described here are consistent with columnar, tabular and similarly complex page layouts. Columns, tables, runarounds and the like may be specified in the scripting by special characters (whose inclusion in the text may be indicated by escape sequences) according to well-known methods. Columns are advantageously rendered in the order of the text flow. Tables are advantageously rendered one row at a time. Once all the cells of a row have been rendered, any adjustments needed for vertical (i.e., bottom-edge or centered) alignment of cells with the row will have been determined. Any further adjustments (including the possible repetition of the rendering process as described above) needed to handle such complex text (including such features as merged cells) will be clear to those skilled in the art.

Cursors

A cursor object represents the user's current position in navigating through the network of loci on a page. It functions both as a visual screen cursor, showing the user's current and potential next positions, and as a programmatic data cursor, maintaining a view of the state of the data objects that currently pertaining to the user's changing position. These include not only the user's current locus, but also references to the current editor, selector or (subsidiary) roster, if these exist, as well as any current (or pending) action initiated by the user. In general, a page has one root cursor for the main body of the page and zero or more child cursors for subsidiary dialogs (discussed below).

A cursor is visually presented to the user as a cluster of four triangles (or similar directional shapes) at the user's current locus, pointing in the four directions of the display screen: to the right, down, to the left, and up. The elements that point in directions in which the user may move the cursor from this point are shown in a more prominent color than the rest (i.e., highlighted). (Triangular cursor elements are shown in the accompanying figures.) In addition to this main cursor element at the user's current location, the cursor displays outboard elements at all neighboring visitable loci that lie in a direct line from the user's location in each of the four directions; these outboard elements take the form of a triangle (or whatever directional shape is used) pointing in the applicable direction, shown in the (“unhighlighted”) less prominent color of the main cursor element. When the cursor is at any given point in the text of a paragraph, the cursor will be brought to the next visitable locus in any given direction (as indicated by an outboard cursor element) by pressing the corresponding arrow key.

Each cursor element, whether main or outboard, is displayed to the immediate left of the phrase text its locus carries. The phrase text is displaced to the right to make room for the cursor element; this space is closed when the cursor is hidden.

Unless a paragraph is open as the user's current paragraph (with the cursor on or to the right of the launch locus), only its marginal locus (or its launch locus, if the cursor is on its marginal locus) will be marked by an outboard cursor element.

(If a visitable locus is replicated, its replica loci are not made visitable. Cursor elements are displayed to the left of the first locus in a replicated series, while any subsidiary roster and/or dialog (see below) is displayed immediately below the last (rightmost) replica locus that lies at the beginning of a line; or on the original locus is the entire series lies on a single line.)

It will be seen that the main and outboard cursor elements serve the user as visual anchors, not only showing the current position and those to be reached by proximate moves, but also providing points of focus as the physical locations of phrases and paragraphs shift.

Highlighting

In addition to the various cursor elements, the user's current position is visually set off by means of progressive levels of highlighting. The currently open paragraph is highlighted a level above the others, the current locus a level above the current paragraph, the current item in an action roster (if any) a further level up. The text and background colors for these progressive levels may be advantageously determined by taking the text and background color from the applicable kit for the base level, determining the highest possible level as (say) pure black on white, and grading all intermediate levels by interpolating between these two extremes along an axis of color value or luminance. This scheme, using a gray scale, is followed in the accompanying figures.

Cursor Movement

When a page is first opened, its root cursor will first appear at the first visitable locus on the page. This will generally be on the marginal locus on the first visitable paragraph. (One exception: if the page has only a single visitable locus, the cursor begins there and cannot be moved from there.) This beginning location is the top-left-most locus on the page. From there, the user will be generally moving the cursor to the right and/or down to go forward, generally opening up new pathways are he or she proceeds. The user may go back (in “reverse,” so to speak) over those moves by moving the cursor either up or to the left.

Two features are of advantage in connection with this:
(1) There is only one leftward or upward path connected to any given position of the cursor in a paragraph's text, i.e., the reverse of the rightward or downward path by which it would have reached its location. Therefore, presses of the left- and up-arrow keys may be interpreted interchangeably, i.e., by moving the cursor in the available “reverse” direction, whether it is leftward or upward. Thus, by repeatedly pressing the same key, the user can move the cursor “in reverse” more easily than by having to press the key corresponding to the actual direction of movement.
(2) The outboard cursor elements discussed above may not be sufficient to provide a complete visible context for the user's current position—that is, a visible trail from the user's original locus to his or her current one—particularly if it was reached by a complex sequence of rightward and downward moves. The loci at which outboard elements were previously shown—particularly the marginal loci of visitable paragraphs—will generally not lie in a direct line from the user's current location. The trail of these loci—which are advantageously displayed as small dots, bullets or other non-directional shapes, to distinguish them from outboard cursor elements (and to minimize visual clutter—may be maintained as follows: On moving rightward from any locus, a pointer (or reference) to that locus is appended to a locus trail array. (Moving leftward over the same path removes the locus from the array.) On drawing the cursor, for each locus in the locus trail array that does not lie in the succession of leftward links as the cursor's, current locus, a dot (or similar shape) is displayed at all locus positions in a direct vertical line from that locus.

FIG. 1 shows a page with the cursor on the marginal locus of the first paragraph, which is closed.

FIG. 2 shows the same page with the cursor on the main text of the first paragraph. The paragraph is open, displaying the available action nodes. Note also the locus trail in the margin.

When the cursor is moved to a visitable phrase-bearing locus, the locus is opened. Similarly, when the cursor is moved away from such a locus, the locus is closed. (The details of opening (and closing) loci bearing specific types of phrases—i.e., editors, selectors and phrases carrying phrase actions—are discussed below.) Opening such a phrase-bearing locus generally displays a subsidiary roster of items, at the current cursor location, from which the user may select. In such a case, an outboard cursor element on the roster's first element—which is displayed immediately below or to the right of the main cursor element—indicates that the cursor may be moved onto the roster, along with the direction being indicated on the main cursor element.

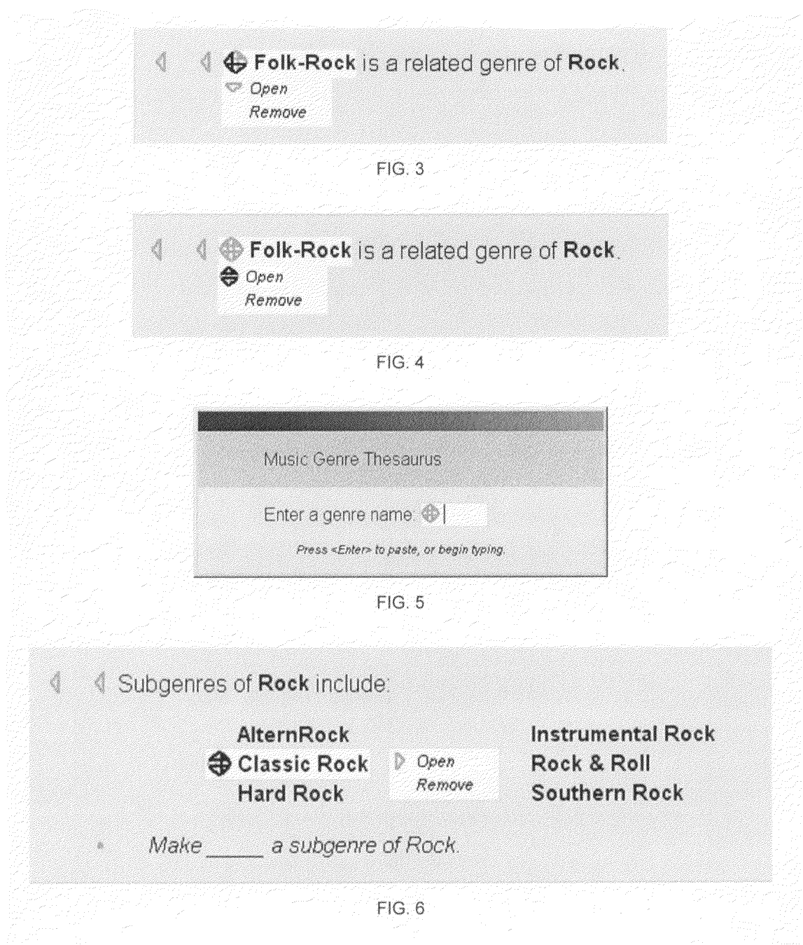

Such a subsidiary roster is shown in FIG. 3—in this particular case, a phrase action roster indicating actions that may be taken on the phrase.

When the cursor is moved from a phrase-bearing locus onto its subsidiary roster (FIG. 4), the main cursor element remains as a stationary cursor at the main locus—showing all four directional elements without any highlighting—in addition to the current, active cursor now shown on the roster.

(A stationary cursor is also advantageously used when there is a single visitable locus on a page, as in the introductory page shown in FIG. 5.)

Phrase rosters—those displaying representing the data of roster phrases, as distinct from subsidiary rosters—are traversed with the main cursor element, without the use of a stationary cursor, as shown in FIG. 6.

When on a subsidiary roster or a phrase roster, the cursor appears to the immediate left of the current element, with available directions highlighted. To avoid visual clutter, no outboard elements are used in the roster. (See FIGS. 4 and 6.)

Subsidiary Dialogues; Spawning Cursors

Actions initiated by the user (at the user's current locus, as reflected in a cursor) comprise input, to which the system may need to respond to the user. In such a case, the user's action invokes a subsidiary dialogue between the system and the user with regard to the user's current action. (The formal stages of this dialogue are discussed under Actions, below.) The subsidiary dialogue is effected using the same method of generating phrase sequences described above, advantageously in a newly ‘opened’ region of the page, shown in a distinct color scheme, in proximity to the user's current location. If this interchange admits of any further action by the user, the system provides a child cursor for the user to navigate the generated text.

In a subsidiary dialog, the system begins its response by generating a response node, which, when realized, provides a child locus for the current cursor.

Although a child cursor may not be placed on any locus carrying the response node's text (particularly if its locus sequence has no visitable phrases), its parent cursor keeps track of the locus initially assigned to the child cursor, enabling proper destruction of the child locus sequence when the child cursor is destroyed.

Rendering Properties: Styles and Kits

Various data used in rendering, such as fonts, margins, inter-paragraph spacing and the like, are carried in two classes of objects: styles (carrying font metrics as well as margin and spacing values) and kits (carrying fonts and colors). While a style is associated with a page, a kit may be associated with an individual phrase, or a (sub)class of phrases, as well as with a page. In the thesaurus example, the class of term phrases is associated with a kit carrying a bold font, so that all terms are shown in bold.

Prompts

When the cursor is on a phrase that accepts user input, or when a subsidiary dialog is awaiting the user's response, a prompt is advantageously displayed to instruct the user as to how to proceed. A typical prompt might read, for example, “Press <Enter> to proceed, <Esc> to cancel.”

Prompts are provided essentially for users whose acquaintance with the user interface (or with the particular element at the cursor) is slight. More expert users should be able to ignore prompts, to the extent that they already know their possible next moves. Accordingly, the text of a prompt should be in practice convey no more information than the particular physical moves available to the user at that point.

To distinguish them from the main text and other elements of the user interface, prompts are advantageously displayed in small italics, centered, below the line containing an open editor, selector or control, immediately below any subsidiary roster (The prompt “Press <Enter> to paste, or begin typing” appears above in FIG. 3.) If the cursor is on a (main-text) roster, any applicable prompt is displayed below the roster. If a subsidiary dialogue is open, the prompt is displayed below the text of the dialog.

As with kits, prompts may be associated with either individual phrases or classes of phrases; a prompt associated with an individual phrase overrides the class prompt.

Actions, in Detail

Actions whereby a user may modify data are represented by action objects, which have two subclasses, node actions and phrase actions.

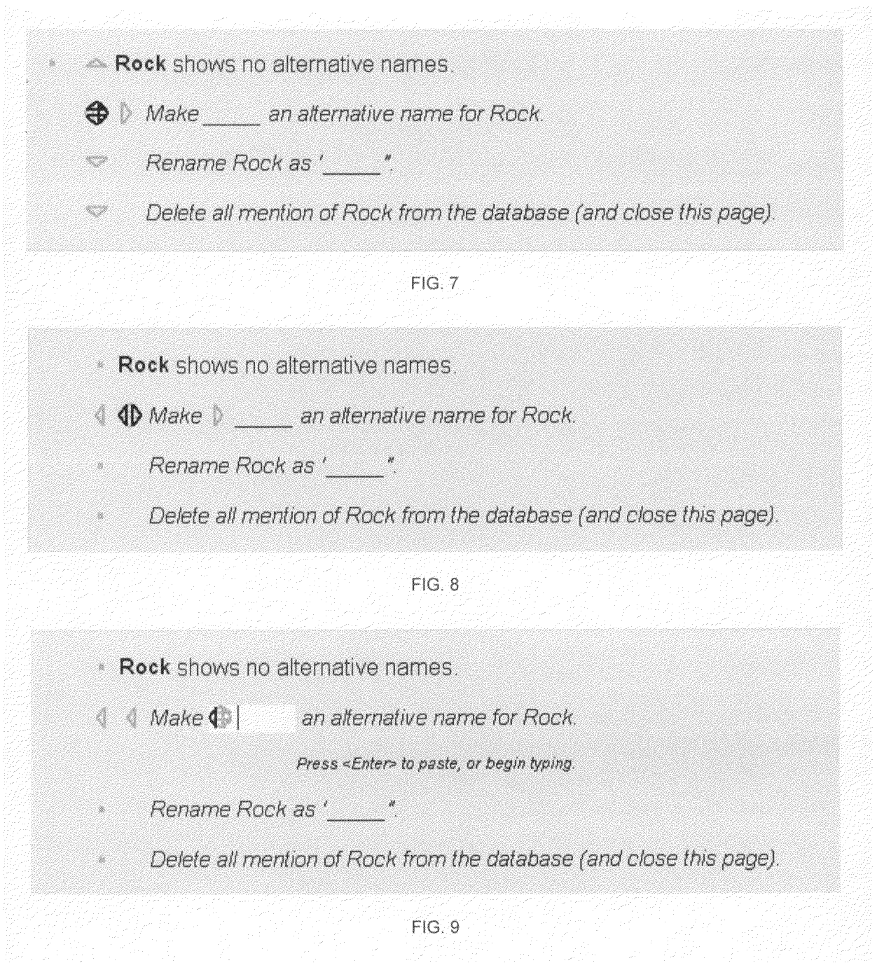

Node actions are associated with particular nodes. For example, the relation node of our thesaurus example, in the realized case of listing the subgenres of Rock, might have a single node action enabling the user to add a subgenre. Its propose node (as realized) might read: “Make ______ a subgenre of Rock.” (The blank represents an edit phrase, to be filled in by the user. See User Input: Editors, Selectors and Graphic Controls, below.) When a paragraph containing one or more such nodes is opened, the propose node (less formally referred to as the “action node”) of each associated action in turn is displayed as a subparagraph below the parent node. For each propose node, an indented marginal locus appears below, and is linked downward from, the parent node's launch locus. To further distinguish them from their parent nodes, the text of propose nodes for actions is advantageously displayed in italics, in the manner of stage directions; it may be further distinguished by appearing in smaller type than the main text. As with the parent node, moving the cursor from the propose-node subparagraph's marginal locus onto its launch locus opens the subparagraph, displaying outboard cursor elements at any visitable loci within the subparagraph. Moving the cursor out of the subparagraph hides the outboard cursor elements; moving the curs/or out of the paragraph hides the subparagraphs (FIGS. 7, 8 and 9).

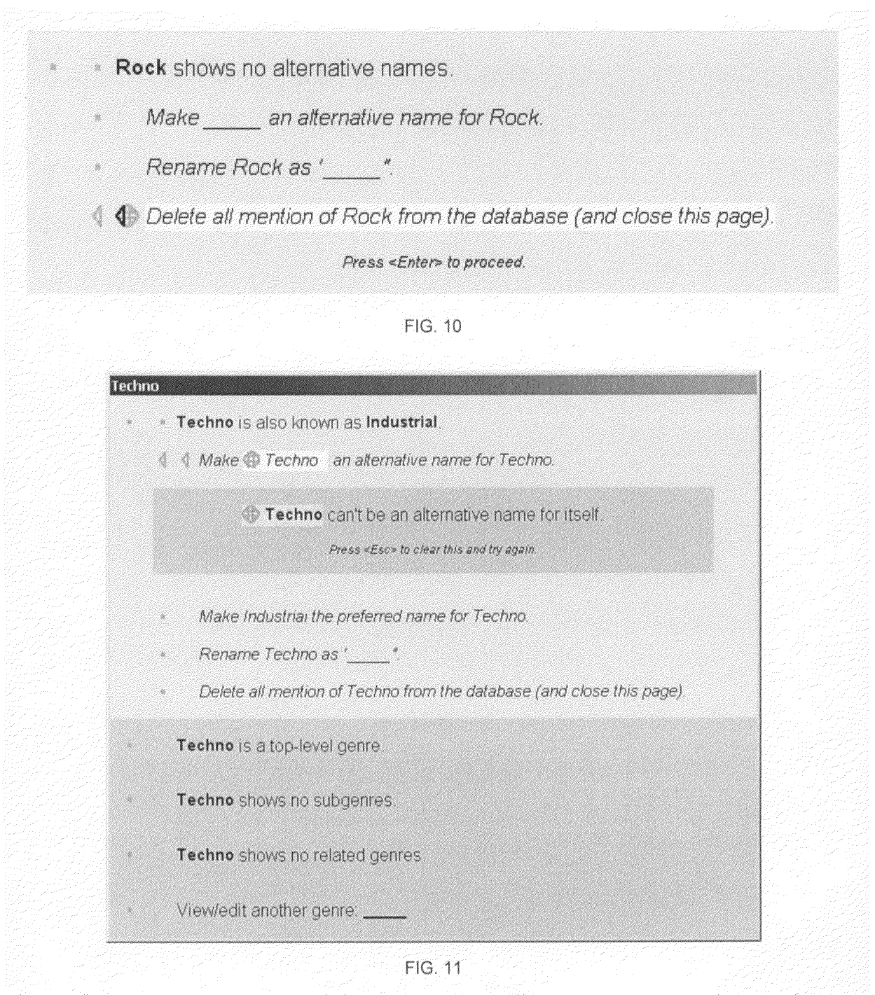

Opening the subparagraph of an action (propose) node bearing no visitable phrases highlights the entire text of the node (FIG. 10).

In practice, nodes and their associated node actions should be designed and scripted so that the user can intuitively know which paragraph on a page to open in order to modify the data relation(s) it describes.

A node action is associated with a node that states some relation among data elements. A phrase action, by contrast, is associated with a particular phrase within a node. By way of example: Adding a subgenre is a node action, having to do with the subgenre relation described by the node—but deleting a subgenre is associated with the particular phrase that corresponds to the subgenre in question. Rather than the complete sentence of the propose node that typically identifies a node action, a phrase action is identified by its name—a short string that names the action, such as “Open,” “Remove,” or “Delete.” Since they designate actions, these are advantageously displayed in italics and/or smaller type than the main text.

Rather than being displayed as subparagraphs of the node, the names of the phrase actions associated with a phrase are displayed, when the cursor is placed at the phrase, in a subsidiary action roster located immediately below the phrase text (see FIG. 3). The remainder of the page's contents, including any lines remaining in the paragraph text below the line containing the phrase, is displaced downward to make room for the action roster.

Phrase actions may also be available on elements of phrase rosters. The action roster in such cases is displayed immediately to the right of the applicable roster element, and any columns lying to the right are displaced to the right to make room for the action roster (FIG. 6).

Each action, whether a node action or a phrase action, is associated with four stages:
1. Raw entry: The user enters any required data and presses return (or double-clicks the mouse).
2. Validation: The system may call a validation function carried by the action object, which may build a response node bearing an error message if the user's action (or, typically, the data entered) is unacceptable.
3. Confirmation: The system may build, by means of a confirmation function, a response node bearing a message warning the user of possible consequences of carrying out the action, or may simply prompt the user to confirm the action (see Prompts, below).
4. Execution: The action is carried out.

Each of the last three stages is associated with a function pointer (or similar ‘functor’) carried by the action object, pointing to an application-specific validation, confirmation or execution function that takes a pointer (or reference) to the paragraph as an argument.

The validation and confirmation functions may script the response node in the manner described above under Realization and Refreshment, Scripting and Loci. The response node can thus make reference to paragraph data.

Node actions carry an additional functor which builds the propose node (discussed above under Paragraphs and the Locus Network) in a similar manner. An optional functor pointing to a filter function may be used to determine, based on current paragraph data, whether to display the particular propose node for a particular action. For example, the action of making a non-preferred synonym for a term the preferred term (with propose node “Make ______ the preferred term . . . ”) should not be presented for a term without any synonyms. Alternatively, the scripting function pointed to by the propose functor might build an empty node in such cases.

Upon the user selecting a phrase action from a roster, or upon completing any data entry required by a node action, the action is staged, that is, brought through its successive stages by calling the corresponding functors in turn: The validation function, if any, is called; and if an error is found, the user is presented with the text of a response node in a subsidiary dialogue explaining the error, along with a prompt advising the user to press the Escape key (or other predetermined action) to try again. Otherwise the confirmation function (if any) is called. The confirmation function may build a response node with a warning about the consequences of the action, which is similarly presented in a subsidiary dialog, along with a prompt advising the user as to how to proceed with or cancel the action (e.g., “Press Enter to proceed, Escape to cancel.”).

The validation and confirmation stages of an action may be skipped, in which case the corresponding functors may be specified as null, or alternatively carry empty functions. An action may also specify that the confirmation stage always present the user with a prompt (with the option to proceed with or cancel the action), even when the confirmation function is absent or does not build the confirmation node.

FIG. 11 shows a page in the validation stage of an action. Here, the response node shows an error message, as well as a prompt, in the subsidiary dialog.

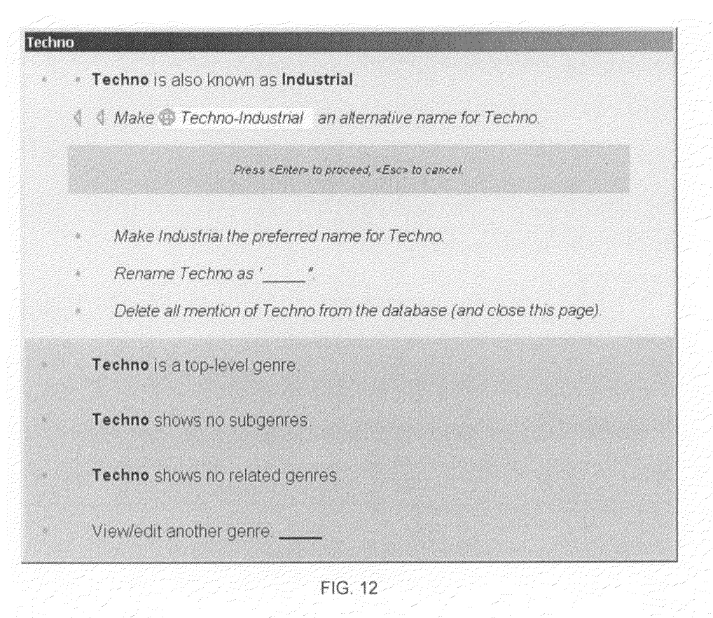

FIG. 12 shows the same page at the confirmation stage of the same action, with a prompt and no response node.

User Input: Editors, Selectors and Graphic Controls

Certain data-bearing phrases, termed user phrases, may accept input of data values from the user in addition to displaying data values. Edit phrases are associated with editors, which enable the user to enter values by means of keyboard or other character input. Select phrases are associated with selectors, which enable the user to select one of a number of possible data values. Control phrases are associated with graphic controls, which may enable the user to modify data by a variety of means. Editors, selectors, and graphic controls associated with these various classes of phrases are opened when the user navigates to the corresponding phrases.

All subclasses of user phrases are realized and rendered in a similar manner to the data-bearing phrases discussed above. All actual phrases of these types are implemented as subclasses of an abstract base class (i.e., edit, select or control phrase). Similarly, all actual instances of the three subclasses of user phrase data objects (edit phrase data, select phrase data and control phrase data objects), as well as all instances of editors, selectors, and controls, are implemented as subclasses of the applicable abstract base class. Specifically: realizing an edit phrase generates an edit phrase data object; realizing a select phrase generates a select phrase data object; and realizing a control phrase generates a control phrase data object. These phrase data objects, in turn, carry editors, selectors and graphic controls, as applicable.

In addition to a refresh function that loads initial or current data values from the applicable paragraph, each actual subclass of any of the three phrase classes carries a propagate function that propagates to the paragraph any data value input by the user.

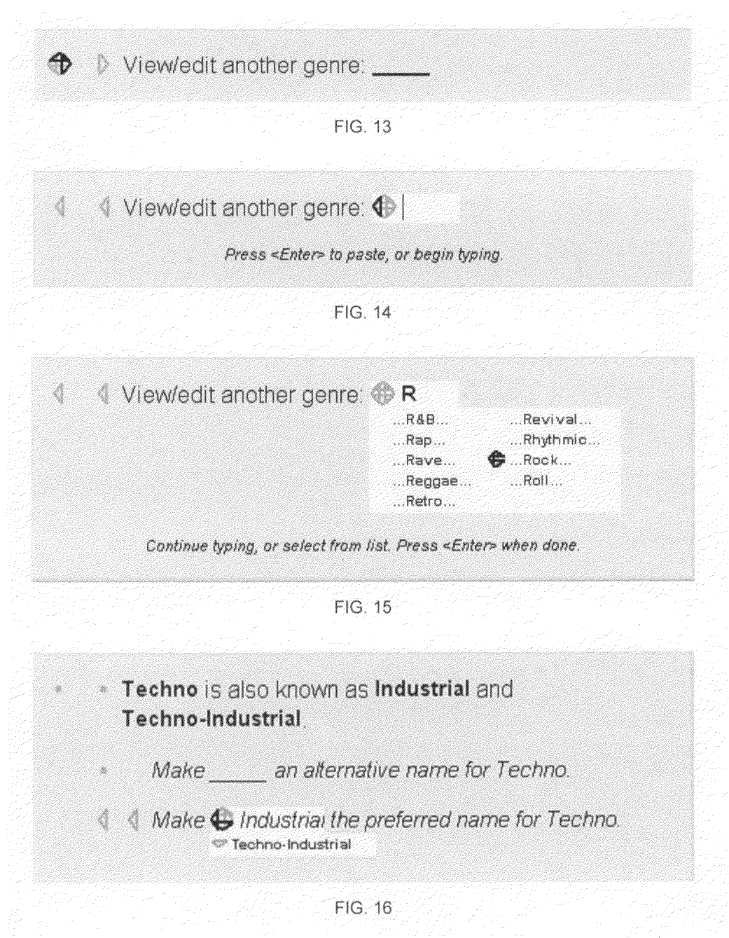

As realized, an edit or select phrase (particularly in its initial state) may have no data value, in which case it is displayed as an empty underscore or similar “blank” representation (FIG. 13).

Opening an editor entails highlighting the text area occupied by the phrase text and displaying the system caret at a point in that area where the user may enter characters. If the phrase is initially blank, the highlighted area covers the length of the blank and the system caret is displayed at the leftmost edge of the formerly blank area. Otherwise, the system caret is placed to the right of the existing text. As the user enters characters, a predetermined “headway” space is maintained to the right of the system caret to suggest further room for insertion of characters (FIG. 14).

Editors may advantageously make use of hint rosters, which are subsidiary rosters that supply suggestions for the word or phrase being entered. In order to use a hint roster, an actual editor must maintain a source array of possible phrase values, and optionally a source array of possible word values. These source arrays have as their elements pointers of indeterminate type (e.g., void* in C++), each of which points to an application-specific object (termed a word object or a phrase object) corresponding to a particular word or phrase. To display possible phrases, the application-specific subclass of the editor class must implement the following functions:

| | |
|---|---|
| String | Given a pointer to a phrase object, returns the |
| getPhraseString( | corresponding text string. |
| void *pPhrase ) | |
| bool findOrAddPhrase( | Given a text string, and a reference to a |
| string sPhrase, | pointer to a phrase object, assigns the pointer |
| void*& pPhrase ) | to the phrase object corresponding to the |
| | given text string. If no such phrase object is |
| | found, creates a new object, assigns the |
| | pointer and returns true; otherwise returns |
| | false. |

To display possible words as well as possible phrases, the application-specific subclass of the editor class must also implement the following functions:

| | |
|---|---|
| String getWordString( | Given a pointer to a word object, returns the |
| void *pWord ) | corresponding text string. |
| void* getWord( | Given a text string, returns a pointer to the |
| string sWord ) | corresponding word object, or a null pointer |
| | if no such object is found. |
| bool phraseContainsWord( | Given pointers to a phrase object and a word |
| void* pPhrase, void* | object, returns true if the text of the phrase |
| pWord ) | contains the word, false if it does not |

As the user enters characters, the hint roster initially displays possible word values (if any are available), changing to possible phrase values (if any) when the user either selects a word from the hint roster or presses a space (or other word-delimiting character such as a hyphen or slash). When possible word values are being displayed, the word fragment currently being entered is highlighted a level above the rest of the text in the editor; ellipses preceding and following each word value advantageously indicate that they represent words rather than phrases (FIG. 15). If the user selects a word from the hint roster (as by pressing the Enter key), the word replaces the highlighted word fragment and the editor displays any available phrase values containing the selected word.

An editor may extend past the end of a line of text, in which case it is continued on the next line. As this involves more than one locus, it is necessary to keep track of the current locus corresponding to the current insertion point in the editor as characters are added and deleted, or as the insertion point is moved, or as the loci carrying an edit phrase are replicated in the rendering process. As the current locus is adjusted in this manner, it is necessary to keep any hint roster associated with an appropriate locus in the series of loci associated with the editor: for editors spanning lines, this is advantageously the last locus that begins a line in the series, so that the entire series is presented together without interruption. It is of further advantage to align any hint roster below the first locus in the series.

An editor may be restricted to the fixed set of available words and/or phrases. A restricted editor accepts input of characters only so long as the word fragment entered in the text area matches one or more of the word or phrase choices shown in the hint roster. When the last character entered by the user causes that word fragment to match a single word or phrase choice, the word or phrase choice is advantageously displayed in the text area, along with a prompt advising the user to press a key (e.g., Enter) to proceed with that choice, or another key (e.g., Backspace) to change it. If the user attempts to enter a further character that causes the word fragment not to match any of the available word or phrase choices, an appropriate prompt to that effect is advantageously displayed.

Selectors enable the user to select a data value from a roster. These values are carried in an array of select items, each of which in turn carries a string representing its text and a pointer of indeterminate type to a corresponding data object. The selector's array of select items is loaded by the corresponding phrase data object's refresh function.

Two subclasses of selector items are function select items, in which the pointer member points to a function executed when the item is selected, and action select items, in which the pointer member points to an action object which is staged when the item is selected.

Opening a selector entails highlighting its text area (i.e., the area occupied by its current value) and displaying a subsidiary roster showing all possible choices other than the one, if any, displayed in the text area. (On opening a blank selector, the highlighted area covers the length of the blank and the subsidiary roster displays all choices.) (FIG. 16.)

As with an editor, the text area of a selector may extend past the end of a line of text, in which case it is continued on the next line.

Editors and selectors may be compared to controls in current use that are known by various names, such as edit boxes, list boxes and combo boxes. Current practice confines both the editable area and the selection list in an editable control to fixed rectangles. Moreover, selection lists are confined to a single column, only a portion of which is usually visible; lists exceeding the depth and items exceeding the width of the rectangle are truncated. Although the rectangle may be manually resized, its width is coupled to that of the editable portion of the control and does not adapt to the data it contains. By contrast, editors and selectors avoid such truncation both by spanning lines and making use of (hint and selection) rosters that present data in a rectangular, potentially multiple-column arrangement that may potentially occupy the full available width of the page (or may force resizing of the page).

Graphic controls of any type, including those in current use, may be embedded in any phrase sequence, in the same manner as editors and selectors, by means of control phrases, which are analogous to edit and select phrases. Each control phrase class has an associated control class, which carries functions for creating and destroying the control, placing the control with respect to its locus, accessing any text carried by the control, and refreshing and propagating data associated with the control. The control phrase data objects associated with control phrases carry refresh and propagate functions, in the same manner as their editor- and selector-associated counterparts, which apply the control class's refresh and propagate functions to the paragraph's (or other data context's) data. Each control phrase data object carries a single graphic control, which is constructed and destroyed, respectively, in the course of constructing and destroying the control phrase data object. Therefore, a particular control phrase may appear only once in any realization of a paragraph. (If more than one instance is needed, additional control phrases may be constructed with identical member methods.)

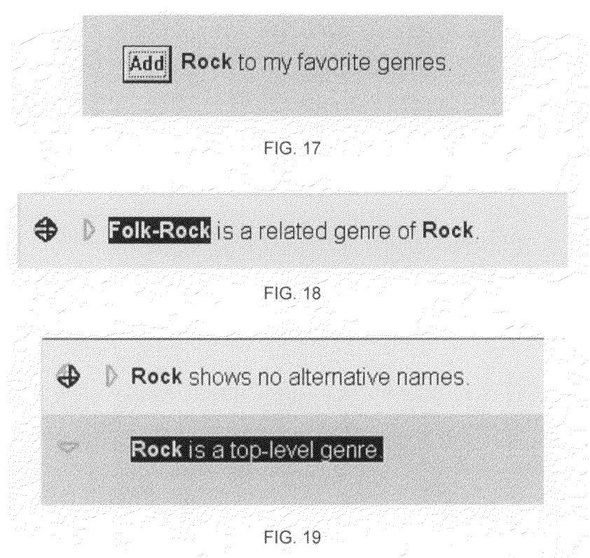

A graphic control phrase embedded in a phrase sequence may display text that forms part of the phrase sequence, as illustrated by the pushbutton control in FIG. 17. To align the baseline of this text with that of the phrase sequence, the control class advantageously carries a shim (a vertical adjustment analogous to the shim for aligning fonts, disclosed above), which is used to align the baseline of the control's text with that of its containing line.

(FIG. 17 also illustrates the use of a normal text node with an embedded control, rather than an action node, to perform an action; this action may be performed by the control phrase's propagate function.)

A graphic control may be provided on the page independently from any phrase sequence by means of a control node, that is, a node that is always realized as a phrase sequence composed of a single control phrase. A control node may appear anywhere in the sequence of nodes that make up a paragraph, or it may be a paragraph's only node.

Keyboard, Voice and Mouse

The directional arrow keys, as noted above, are used to move the current cursor from one locus to the next in any available direction. Subsidiary rosters, including action, edit and select rosters, are reached by pressing the down-arrow key (when they appear below the main text) or the right-arrow key (when they appear to the right of a roster element).

When the cursor is on the first element of a roster, pressing the left- or up-arrow key (as appropriate) moves the cursor from the roster back to the main text. Outboard cursor elements are advantageously displayed at the first element of a roster, or at the main-text phrase or proximate roster element(s), as appropriate, to indicate that these moves are available.

All rosters, both those carrying roster phrases and subsidiary rosters, are navigated by means of the arrow keys, which may also be used to enter rosters from the main text and to return to the main text from a roster.

The Tab key may be used in place of the right-arrow key, and Shift-Tab in place of the left-arrow key, especially when moving between loci.

Two other keys besides the arrow keys play important roles in this user interface method: The Enter (or carriage return) is generally used to select, open and or proceed with some element or operation at the cursor. Inversely, the Escape key is generally used to cancel an operation or retreat from the cursor's current location. The combination of arrow keys, Enter and Escape may be advantageously translated to devices, particularly portable and handheld ones, with fewer keys than computers. One such device is a cellular telephone, which might use the directional joystick in place of the arrow keys, the Call key in place of the Enter key, and the End-Call key in place of the Escape key.

Specifically, pressing the Enter key:
(1) when the current cursor is on a subsidiary (edit, action or select) roster, accepts the item at the cursor; if on an action roster, initiates the corresponding action
(2) when the current cursor is on an editor:
   a. if the user has entered any characters into the editor, accepts the string of characters that the user has entered (for a word or a phrase, as appropriate)
   b. if nothing has been entered, pastes the contents of the clipboard into the editor
   c. if the phrase associated with the editor carries an action, initiates the action
(3) when the current cursor is on an editor or selector in an action node, moves the cursor to the next (or the first) editor or selector in the node without a selected item; if none exist, the node's action is initiated
(4) when the current cursor is on the launch locus of an action node without any visitable phrases, initiates the action
(5) when the current cursor is on the confirmation node of a subsidiary dialog, confirms the user's intention to proceed with the action, which is then executed

Pressing the Escape key:
(1) when the current cursor is on a subsidiary (edit, action or select) roster, moves the cursor back to the corresponding phrase locus or roster item, as applicable
(2) when the current cursor is on a visitable phrase in a paragraph, whether or not a roster phrase, moves the cursor back to the marginal locus of the paragraph, closing the paragraph
(3) when the current cursor is on the marginal locus of a paragraph, closes the page
(4) when the current cursor is on an editor's word or phrase roster, moves the cursor back to the editor
(5) when the current cursor is on the response node of an action in the validation stage (generally indicating to the user an error state), closes the subsidiary dialog displaying the error node and returns the cursor to the locus from which the subsidiary dialog was launched
(6) when the current cursor is on the response node of an action in the confirmation stage (also displayed in a subsidiary dialog), disconfirms the user's intention to proceed with the action, closing the subsidiary dialog displaying the confirmation node and returning the cursor to the locus from which the subsidiary dialog was launched

Pressing the Escape key truncates the locus trail array to include only those loci that lead to the new position.

Voice commands may be advantageously used instead of keystrokes for all keyboard input. Dedicated keywords such as “left,” “down,” and “up” may be used in place of the arrow keys; and “go” and “back,” respectively, in place of the Enter and Escape keys. The words and phrases presented in edit and select rosters may be accompanied by stored waveform or similar sonic profiles (according to well-known methods) to enable their recognition. Letters and other characters may be similarly input by their names, with recognition similarly enabled; and shift states (e.g., upper or lower case) set by means of dedicated keywords such as “shift” and “unshift.” In all of these cases, the limited set of voice commands made available at any given state of the user interface—and clearly indicated to the user by means of the visual presentation—will aid the system in discriminating among the available voice commands.

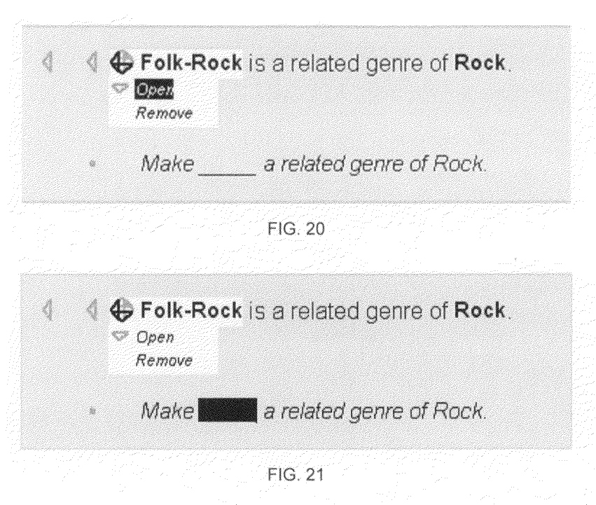

As an alternative to successively pressing the arrow keys or uttering voice commands to reach a particular locus, the mouse (or a similar pointing device, such as a stylus or a touchscreen) may be used to move directly to any valid location on any displayed page. When the user moves the mouse to any physical point on the page (except, perhaps, in the margins or between paragraphs; this point is referred to below as the mouse point), a mouse locus, which will be made the current locus if the mouse is clicked there, is advantageously determined and displayed as follows:
(1) When the mouse cursor is at any point in a paragraph with at least one visitable phrase, the locus of the visitable phrase to the mouse cursor is made the mouse locus and the phrase advantageously shown with its foreground and background colors reversed (FIG. 18).
(2) When the mouse cursor is at any point in a visitable paragraph or subparagraph without visitable data-bearing loci, the (sub)paragraph's launch locus is made the mouse locus and the entire text of the (sub)paragraph advantageously with its foreground and background colors reversed (FIG. 19).
(3) If an editor is open and the mouse point is within the main editor text, the editor is shown “blank” as it would be for input of text, but with its foreground and background colors reversed (FIG. 20).
(4) Otherwise, if a subsidiary roster (a hint roster, a selection roster, an action roster, etc.) is open and the mouse point is within the bounds of that roster, the roster item whose central point is determined to be nearest to the mouse point is shown with its foreground and background colors reversed (FIG. 21). The roster is made the current mouse roster and the item made the current mouse roster item.
(5) Otherwise, the locus whose central point is determined to be nearest to the clicked location is made the current mouse locus and displayed with its foreground and background colors reversed.
(6) If the clicked location is within the bounds of a phrase roster (but not on a subsidiary roster), the roster is made the current mouse roster and the roster item whose central point is determined to be nearest to the mouse point is made the current mouse roster item and displayed with its foreground and background colors reversed.

When a mouse button (advantageously, the left mouse button) is pressed (or, alternatively, released after being pressed), the mouse's logical location is made the current location, as follows:
(1) If an editor is open and the mouse point is within the main editor text, the editor's insertion point is moved to the correspond place in the editor text.
(2) Otherwise, if a subsidiary roster is the mouse roster, the mouse roster item is made the current item for that subsidiary roster.
(3) Otherwise, if there is a current mouse locus, the cursor is moved to that locus.
(4) If the mouse roster is a phrase roster, the mouse roster item is made the current item for that phrase roster and, if applicable, a subsidiary action roster is displayed to the right of that item.

On this pressing (or releasing) of the mouse button, the state of the display is updated to the exact state it would have assumed had the user navigated using the arrow keys from the previous location to the new one. If the user has moved from one location to another in an editor, the system caret is placed at the new location. If the user has moved onto or within a subsidiary roster, the cursor is placed at the new location in the subsidiary roster and the corresponding roster item appropriately highlighted. If the user has moved to a different locus, all appurtenances of the cursor at its original locus are closed, as well as the paragraph (if the new locus is in a different one), and any applicable new appurtenances of the cursor (as well as the paragraph, if applicable) are opened at the new locus, and the locus trail is reconstructed to the same state as if the user had navigated to the locus from the paragraph's marginal locus.

As the physical location of the mouse locus may shift when the mouse button is pressed (or released), it is of further advantage to move the system's mouse cursor immediately to the new location. When an action that re-realizes the paragraph (or the page) due to changed data results from a mouse click, it is of similar advantage to move the system's mouse cursor immediately to the new location of the clicked locus—or, if there is none, to a suitable locus such as the paragraph's marginal or launch locus.

Although the present invention has been described in connection with particular applications thereof, and the preferred embodiment thereof described in detail, modifications and adaptations may be made thereto, and additional embodiments and applications made thereof, which will be obvious to those skilled in the art, without departing from the spirit and scope of the invention, as delineated in the following claims.

I claim:

1. A user interface that displays a sequence of one or more paragraphs of text, each said paragraph comprising a predetermined sequence of one or more semantic nodes, each said semantic node comprising a sequence of zero or more phrases, wherein, for any said paragraph, said sequence of phrases is determined by the current state of a predetermined set of data associated with said paragraph, according to a predetermined procedure associated with said semantic node.

2. The user interface of claim 1 wherein a said phrase carries a fixed text value.

3. The user interface of claim 1 wherein a said phrase carries a constant value determined by predetermined data.

4. The user interface of claim 1 wherein a said phrase carries a variable value determined by predetermined data.

5. The user interface of claim 4 further providing data modification means for modifying said variable value at the location where said text phrase is displayed.

6. The user interface of claim 5 wherein said data modification means is an editor that enables a user to enter a string of characters.

7. The user interface of claim 5 wherein said data modification means is a selector that enables a user to select one of a plurality of text strings.

8. The user interface of claim 1 wherein a said phrase carries a graphic control.

9. The user interface of claim 5 wherein said data modification means is a graphic control.
